(19) United States
(12) Patent Application Publication
(10) Pub. No.: US 2025/0304019 A1
(43) Pub. Date: Oct. 2, 2025

(54) REAR BRAKE COOLING DUCT

(71) Applicant: FCA US LLC, Auburn Hills, MI (US)

(72) Inventors: Sreekanth Surapaneni, Oakland, MI (US); Chenglong Wei, Rochester Hills, MI (US); Richard M Maksym, Leonard, MI (US)

(21) Appl. No.: 18/616,314

(22) Filed: Mar. 26, 2024

(51) Int. Cl. B60T 5/00

(52) U.S. Cl. CPC B60T 5/00

(57) ABSTRACT

A vehicle duct for cooling rear brakes has a body defining a channel passing through the body. An inlet is at one end of the duct. The inlet is generally positioned axially with respect to the axis of the vehicle. An outlet is at another end of the channel. The outlet is generally positioned laterally with respect to the vehicle axis. Also, the outlet is angled upward to direct an air flow at a brake rotor.

### FIELD

The present disclosure relates to automotive vehicles and, more particularly, to a duct system for cooling rear brakes.

### BACKGROUND

This section provides background information related to the present disclosure which is not necessarily prior art.

Brake systems often overheat while they are driving downhill or while continuous heavy braking is applied to the brakes. Some common problems caused by overheating of the brake system are brake fade, brake rotor damage, brake fluid boiling to name a few. Generally, the brake rotors are metal disk that absorb the kinetic energy of a moving vehicle. In turn, they dissipate the kinetic energy into the surrounding air as heat. Overheating of the brakes can cause the brake power to be reduced considerably and to lead to longer stopping distances.

Brake ducts provide cooling air that channels the air toward the brake components to help reduce the overheating of the brake components. Traditionally, these ducts have been used on the front brakes as it is easier to draw the cold fresh air into the front of the vehicle. Ducts have not been traditionally used on rear brakes due to the unavailability of ram air. Also, removal of air dam/tire spats, open wheels and the removal of dust shields have been used to cool the brakes.

Brake ducts are not aerodynamical neutral and increase the aerodynamic drag. Removal of air dams/tire spats also increase the aerodynamic drag and is seldom appreciated by aerodynamic engineers. The open wheels is a solution; however, it also increases the aerodynamic drag. The removal of the dust shield or having larger holes avails the brake system to the risk of brake disc damage from stones or debris.

Thus, designers are striving to find solutions to cool the rear brake disc in order to increase the brake efficiency.

### SUMMARY

This section provides a general summary of the disclosure, and is not a comprehensive disclosure of its full scope or all of its features.

The present design provides a brake duct that enhances cooling of the rear brakes. The brake duct collects air passing through the rear of the vehicle and directs it towards the rear brake assembly. Also, the incoming air is directed from the ducts upward toward the brake rotors. The brake duct increases brake cooling efficiency by around 50% compared with vehicles that do have the brake ducts. Also, the present disclosure provides an automatic opening of the duct air brake inlet at desired parameters.

According to a first aspect of the disclosure, a vehicle duct system for cooling rear brakes comprises a body defining a channel passing through the body. An inlet is at one end of the channel. The inlet is generally positioned axially with respect to the vehicle. An outlet is at another end of the channel. The outlet is generally positioned laterally with respect to the axis of the vehicle. Also, the outlet is angled upward to direct an air flow at a brake rotor. A plurality of supports extend from the body to secure the duct with a knuckle. A door is at the inlet of the channel to prohibit air flow into the inlet channel until desired parameters are reached. The door opens automatically when a desired windspeed force contacts the door. A biasing spring opens the door at a desired air speed. Generally, the air speed is at least 50 mph. Thus, the door remains closed when the air speed is below 50 mph.

According to a second aspect of the disclosure, a vehicle with rear brake cooling device comprises a rear knuckle including a rotor. A vehicle duct for cooling the rear brakes comprises a body defining a channel passing through the body. An inlet is at one end of the channel. The inlet is generally positioned axially with respect to the axis of the vehicle. An outlet is at another end of the channel. The outlet is generally positioned laterally with respect to the axis of the vehicle. Also, the outlet is angled upward to direct an air flow at a brake rotor. A plurality of supports extend from the body to secure the duct with a knuckle. A door is at the inlet of the channel to prohibit air flow into the inlet channel until desired parameters are reached. The door opens automatically when a desired windspeed force contacts the door. A biasing spring opens the door at a desired air speed. Generally, the air speed is at least 50 mph. Thus, the door remains closed when the air speed is below 50 mph.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of a brake duct on a vehicle.

FIG. 2 is a schematic view of the brake duct of FIG. 1.

FIG. 3 is an enlarged schematic view of the brake duct with a door mechanism.

FIG. 4 is a cross section view of FIG. 3 along line 4-4.

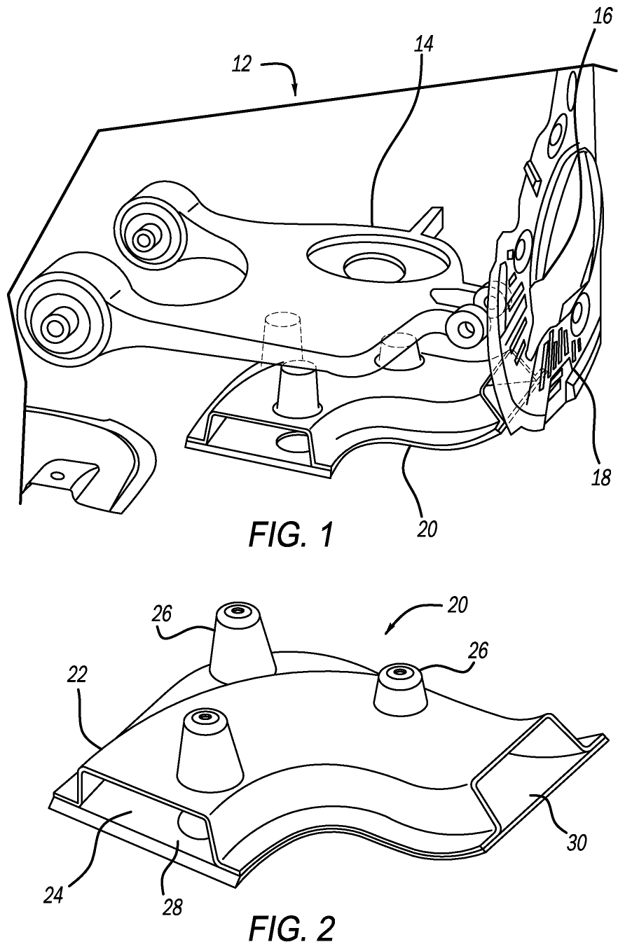

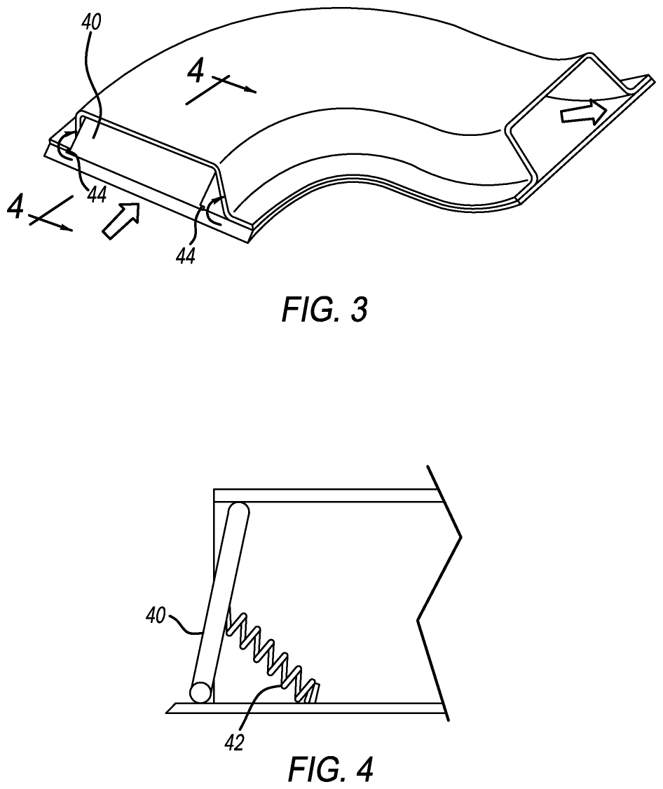

Corresponding reference numerals indicate corresponding parts throughout the several views of the drawings.

### DETAILED DESCRIPTION

Example embodiments will now be described more fully with reference to the accompanying drawings.

Turning to the figures, a vehicle is illustrated and designated with the reference numeral 10. The vehicle includes a rear brake assembly 12. The rear brake assembly 12 includes a knuckle 14, a rotor 16 and a dust shield 18. A brake duct 20 is secured to the knuckle 14.

The brake duct 20 includes a body 22 defining a channel 24 that extends through the body 22. Generally, the body is manufactured from a sheet metal or a stamped material. A plurality of supports 24 extend from the body 22. The supports 24 enable the duct 20 to be secured with the knuckle 14.

The channel 24 has an inlet 28 and an outlet 30. The inlet 28 is generally positioned so that it is positioned axially along the axis of the vehicle. Thus, the inlet 20 is positioned to be acted upon by the air flow underneath the vehicle.

The channel 24 has an overall L-shape so that the outlet 30 is positioned laterally with respect to the axis of the vehicle. The outlet 30 is also angled upward towards the brake rotor. The angle is approximately 20° to 60°, preferably 35° to 45°, illustrated at 40°. This provides for the airflow to be directed at the most efficient angle to cool the brake rotor.

The inlet 38 is generally rectangular and can have an opening size of around 35 to 40 mm by 110 to 120 mm. The outlet 30 generally has a dimension of 35 to 40 mm by 95 mm to 100 mm. Thus, the inlet 28 and outlet 30 generally have an overall rectangular configuration.

A door or flap 40 is positioned at the inlet 28. The door or flap 40 has a self-controlled mechanism 42. When the vehicle speed reaches approximately 50 mph, the flap 40 opens, via the self-controlled mechanism 42, enabling high speed air flow into the channel 24 to bring cooling air to the brake rotor. At a speed below 50 mph, the door 40 or flap remains closed. This reduces the negative effect of the duct to the aerodynamic performance of the vehicle while benefitting the brake cooling.

The door or flap 40 is generally angled with respect to the inlet 28. The door 40 is connected with a biasing mechanism 42 such as a coil spring or the like that holds the door 40 in its closed position. The door 40 includes pivots 44 that enable the door to be rotated as the air speed increases to over 50 mph. As this occurs, the spring 42, due to its design, in the area of the door, experiences a force that overcomes the force of the spring 42. As this occurs, the door or flap 40 opens automatically enabling the air to enter into the channel 24. As the air speed is reduced, the spring 42 overcomes the force of the air flow and returns the door or flap 40 to its closed position. The spring constant can be modified so that the door could open at any desired speed (30 mph-70 mph) to meet the vehicle's brake cooling need. Further, a controller could be used to automatically detect the rotor temperature and control opening of the flap.

The design can be used in conventional vehicles and also in electric vehicles. The minimal aerodynamic drag due to the design is beneficial to be used in vehicles.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A vehicle duct for cooling rear brakes comprising:
a body defining a channel passing through the body;
an inlet is at one end of the duct, the inlet is generally positioned axially with respect to an axis of the vehicle;
an outlet is at another end of the duct, the outlet is generally positioned laterally with respect to the vehicle axis and the outlet is angled upward for directing an air flow at a brake rotor.

2. The vehicle duct of claim 1, wherein a plurality of supports extend from the body to secure the duct with a knuckle.

3. The vehicle duct of claim 1, further comprising a door at the inlet for prohibiting air flow into the inlet until desired parameters are reached.

4. The vehicle duct of claim 3, wherein the door opens automatically when a desired windspeed force contacts the door.

5. The vehicle duct of claim 3, further comprising a biasing spring enabling opening of the door at a desired air speed.

6. The vehicle duct of claim 4, wherein the air speed is at least 50 mph.

7. The vehicle duct of claim 6, wherein the door remains closed when the air speed is below 50 mph.

8. A vehicle with a rear brake cooling device comprising:
a rear knuckle including a brake rotor;
a body defining a channel passing through the body;
an inlet at one end of the duct, the inlet generally positioned axially with respect to the vehicle;
an outlet at another end of the channel, the outlet generally positioned laterally with respect to the vehicle axis and the outlet angled upward for directing an air flow at the brake rotor.

9. The vehicle with a rear brake cooling device of claim 8, wherein a plurality of supports extend from the body to secure the duct with the knuckle.

10. The vehicle with a rear brake cooling device of claim 8, further comprising a door at the inlet for prohibiting air flow into the inlet until desired parameters are reached.

11. The vehicle with a rear brake cooling device of claim 10, wherein the door opens automatically when a desired windspeed force contacts the door.

12. The vehicle with a rear brake cooling device of claim 10, further comprising a biasing spring enabling opening of the door at a desired air speed.

13. The vehicle with a rear brake cooling device of claim 11, wherein the air speed is at least 50 mph.

14. The vehicle with a rear brake cooling device of claim 13, wherein the door remains closed when the air speed is below 50 mph.
